(19) United States
(12) Patent Application Publication
(10) Pub. No.: US 2015/0254403 A1
(43) Pub. Date: Sep. 10, 2015

(54) Electronic Medical Record Interface

(71) Applicant: Lucy LaPerna, New Albany, OH (US)

(72) Inventor: Lucy LaPerna, New Albany, OH (US)

(21) Appl. No.: 14/201,902

(22) Filed: Mar. 9, 2014

(51) Int. Cl. G06F 19/00; G06F 3/0481; G06F 17/24

(52) U.S. Cl. CPC G06F 19/322; G06F 17/241; G06F 3/0481

(57) ABSTRACT

Provided is an interface for an electronic medical record (EMR) or electronic health record (EHR) and methods, and systems including the same.

### FIELD

The present subject matter relates to an electronic interface for Electronic Medical Records (EMR) and Electronic Medical Health Records (EHR), computer-implemented methods of electronic patient charting, and computer-implemented electronic patient charting systems.

### BACKGROUND

Electronic charting and digital information management has been a cornerstone of healthcare reform efforts since the early/mid 1990's. Unfortunately, after the introduction of the electronic medical record (EMR), the workflow of the typical electronic patient chart became more about required documentation, essential elements for maximum allowable reimbursement, coding to meet appropriate use criteria and compliance with federal mandates.

The resultant electronic chart format has lead to medical errors, cloned Subjective Objective Assessment Plan (SOAP) notes and poor communication among physicians and other care takers. In short, many of the effects of the EMR have had the exact opposite impact on patient care than what was originally planned. While the EMR infrastructure carries out the data mining and billing essentials, there is an emerging need for clinically focused improvements.

### SUMMARY

Provided is a novel method of note writing via an electronic overlay product being developed by StreamChRT Inc. The vision of the StreamChRT method is to share pertinent medical information and clinical impressions and recommendations in a more efficient, concise and meaningful manner. The vision is to re-imagine the SOAP note and create a totally new workflow that revolves around a social media style electronic chart interface.

The data that is necessary for billing and coding which are the current elements of a complete SOAP note will be kept in the background EMR system while the entries to the StreamChRT overlay will maintain all of the pertinent clinical communication. Entries in the StreamChRT electronic overlay will be connected to the EMR infrastructure via an interface such as IL7. This interface will allow for a SOAP note to be constructed and used for the billing and data gathering. The substance of the clinical interaction will remain in StreamChRT. Shared data will exist in an integrated toolbar.

This patented workflow will allow physicians to genuinely share information while avoiding redundancy and cloning of notes. This workflow will provide an easy to follow clinically useful portrayal of the patient's care in real time.

The at-a-glance features of StreamChRT will allow for easy recognition of transitions of care, specialty physicians and facial recognition of caretakers. These recognition features of the StreamChRT method of electronic charting will enable physicians to bill the maximum allowable service via the EMR SOAP note while minimizing redundant and burdensome charting.

Provided is a computer-implemented method and system for interfacing electronic medical or health records with one or more graphical displays. The system may comprise or consist of at least one graphical interface, EMR software, e.g., EPIC® software, at least one user input station, at least one storage device, e.g., a hard drive or cloud storage system, electronically connected medical devices, e.g., patient monitoring devices, and/or a network or link connecting one or more of the same. Data may be input by a user into the graphical interface. Additionally or alternatively, data may be input into the EMR directly. Data may also be extracted from a linked device. All data may be pushed or pulled enabling real time updates to the interface and the corresponding EMR.

The computer-implemented system or method for maintaining and/or updating electronic medical records may comprise or consist of inputting data into a graphical user interface, the interface comprising or consisting a display environment comprising one or more patient images. The display environment may also comprise or consist of one or more hyperlinks toggling to collaborating specialists. In addition, the display environment may also comprise or consist of individualized preset font preferences that accompany each health provider's notes allowing for at-a-glance identification of a specific physician or physicians. Further, the graphical user interface may comprise or consist of color code areas corresponding to transitions in care area on the chart displayed by the interface. In addition, entries may be highlighted in order to make review of patient history more efficient. The color code transitions and highlights are an at-a-glance feature configured to allow review events/number of transitions a patient has experienced during care.

In addition, the system or method for maintaining and/or updating electronic medical record may also comprise or consist of inputting data into the graphical interface. Inputting may comprise or consist of providing a keyboard, voice recognition tool, video formats, or the like configured to input data into the interface.

Further, the system or method for maintaining and/or updating electronic medical record may also comprise or consist of a utility for distinguishing between types of health care providers notations to the chart, e.g., doctor, fellow, resident, nurse, nurse practitioner (NP), physicians assistant (PA), pharmacist, nutritionist, etc. The utility may also be configured to distinguish the area of specialty of a health care practitioner. The utility may comprise or consist of an icon, a font-type, a font color, a background color or image, or the like.

Additionally, the system or method for maintaining and/or updating electronic medical record may also comprise or consist of a providing video notes and/or sign out information for specific health care institutions or providers. For example, for teaching institutions a sign out may be under a portion of the chart specific to residents chart so that pertinent sign out information can be handed over for the next covering resident. Video notes may also be specific to various other practitioners and/or areas of care, including, for example, doctors, nurses, specialists, NPs, PAs, etc.

The system or method for maintaining and/or updating electronic medical record may also comprise or consist providing the graphical interface comprising or consisting of a thumbnail side bar comprising or consisting of data in a display environment. The data may be updated in real time as data is input and/or extracted from the electronic medical record or other linked equipment, e.g., patient monitoring devices for vitals, hospital intranet, etc. The data may include information comprising one or more of last 24 hour graphics of patient temperature, heart rate, intake and output, and an active medication list. Upon input of data into the EMR, the interface may automatically display the updated data. Accordingly, a scrolling 24 hour display is always ready to review, the real time thumbnail side bar data following the display environment while scrolling through patient entries so that relevant information is visualized in the thumbnail margin.

The system or method for maintaining and/or updating electronic medical record may also comprise or consist providing virtual remote consultation environment in the interface. The virtual remote consultation environment may be configured such that one or more institutions can communicate with one another via videoconferencing. The method may comprise or consist of recording the videoconference and attaching the same to the EMR for future review.

The system or method for maintaining and/or updating electronic medical record may also further comprise or consist of providing electronic tabs linked to functions and/or additional display environments for inpatient and outpatient care. The tabs may correspond to the same or different medical institutions.

The system or method for maintaining and/or updating electronic medical record may also further comprise or consist of providing laboratory diagnostic testing tabs in a display environment to allow direct communication with one or more health care practitioners. For example, lab results may be inputted by a lab technician into the EMR and the interface may extract the data or the lab technician may simply input the data directly into the interface. Once input or extracted, one or more providers may simultaneously communicate with one another via the interface while reviewing the data.

The system or method for maintaining and/or updating electronic medical record may also further comprise or consist of providing a cloud database configured with secure access from hospital to hospital across with access to healthcare providers controlled by the patient.

The system or method for maintaining and/or updating electronic medical record may also further comprise or consist of providing a patient tab in a display environment configured to allow the patient to communicate via one or more of written, verbal, and video chat with, for example, off-site family or friends in a family conference. Likewise, a healthcare provider may also communicate, via the interface, with off-site family or friends.

The system or method for maintaining and/or updating electronic medical record may also further comprise or consist of incorporating social media elements or features into the electronic medical or health records.

The system or method for maintaining and/or updating electronic medical record may also further comprise or consist of incorporating time/date stamping into electronic medical or health records.

The EMR interface may comprise or consist of a first display environment comprising a digital image of the patient, patient information (e.g. name banner and age, date of birth (DOB), gender (male/female), admitting physician/service, diagnostic codes box), consecutive day medical notes, digital image of admitting physician accompanying medical notes, along with time and date (i.e. time stamp) window. The digital image of the patient may be linked to critical data specific to a patient, which may be accessed manipulating the digital image via the interface.

The patient and doctor identifying information can be displayed in at least one display environment, possibly along with one or more of the following tools in an integrated tool bar, including, for example:
1) VITALS—patient's vitals along with the time and date (i.e. time stamp) and real time vitals;
2) ACTIVE MEDICATION LIST—patient's active medication list along with the time and date (i.e. time stamp);
3) PHYSICAL EXAM FINDINGS—a check list of the patient's physical exam finding along with the time and date (i.e. time stamp);
4) LABORATORY—the patient's laboratory results along with the time and date (i.e. time stamp); and/or
5) TELEMETRY—the patient's telemetry along with the time and date (i.e. time stamp).

The method and system provide a multidimensional display environment that provides a significantly higher level of information content of the patient, physician(s), and treatment records available at-a-glance. This display environment is patient-centric and provides freedom for the caregiver to care for the patient. In addition, this display environment provides recognition for the caregivers involved in the patient's care, and transition of care from one caregiver to the next.

The EMR interface also comprises integrated tabs e.g., a multidisciplinary drop down tab list for different caretaker groups, that may comprise or consist of one or more of the following categories:

1) H&P (History and Physical Examination);

2) MD (Physicians);

3) RN (Registered Nurses);

4) Rad/Card (Radiology/Cardiology);

5) Pharm (Pharmacy);

6) SS (Social Services);

7) PT/OT (Physical Therapy/Occupational Therapy);

8) Resident (Resident physicians);

9) Hosp (Hospital);

10) Orders (Physician Orders);

11) Reports (Patient Reports); and/or

12) any portion of an EMR.

The EMR interface may also comprise or consist of a tool or utility bar for accessing inpatient, outpatient, patient and/or patient's family data. Further, the interface may provide one or more virtual consulting features, for example, to allow a specialist at another hospital to consult with the treating physician and/or patient. Alternatively, or in addition, the interface may provide an environment for the patient to video conference with family and friends.

The interface system and/or method may provide various features, including one or more of:

1) a social media layout with visual patient and caregiver identifiers;

2) colored font to identity transitions of care;

3) real time streaming of patient data;

4) encrypted data storage for future data mining projects;

5) instant communication and collaboration;

6) time stamp technology in real time; and/or

7) a vision for new revenue streams utilizing the social platform.

The interface system and method may also provide one or more of encrypted security of patient data, HIPAA compliance, and meaningful use stages.

The interface is configured to be in communication with the EMR software, at least one user input station, at least one storage device and/or electronically connected medical devices, by any method known to the skilled artisan, for example, a link. The communication between the interface and other elements may be encrypted for security. Communication may be real-time, i.e., “pushed,” or it may occur at pre-determined times, i.e., “pulled,” or may be otherwise manually controlled. Each of the elements in the present system may be linked by any known communication means. In addition, communication between elements, e.g., between the interface and an EMR, may be direct or via a third media.

In addition, any of the methods described herein may be provided in a form of instructions stored on a non-transitory, computer readable medium, that when executed by a computing device, perform functions of the method. In some examples, each function may represent a module, a segment, or a portion of program code, which includes one or more instructions executable by a processor for implementing specific logical functions or steps in the process. The program code may be stored on any type of computer readable medium, for example, such as a storage device including a disk or hard drive. In addition, methods described herein may include one or more operations, functions, or actions that can be performed in a sequential order, performed in parallel, and/or in a different order than those described herein.

The terms “real-time”, “near real-time” and “historical” are defined in relative terms. Real-time data is essentially current data that has been reported or communicated within about the past five seconds from the medical device, while near real-time data is current data that has been communicated within about the past five minutes, and historical data is previously reported data that was communicated at least about five minutes ago and more typically hours, days or longer ago. Historical data is a fairly easy concept to understand because such data was communicated a considerable time ago and therefore does not accurately reflect the current status of the medical device, nor the medication or patient associated with it. A user can analyze historical data for trends and to understand past activities, occurrences or performance, but would not believe the data to represent a current instantaneous status. However, the distinction between real-time and near real-time data is slipperier, blurrier, much harder to make, and depends greatly on the capabilities of the medical device, the communication network, and the graphical interface platform software to communicate, process, and populate all of the data on a particular graphic user interface screen or dashboard. Thus, the term real-time as used herein should be understood to more broadly include near real-time data as well, even when not specifically stated that way.

The graphical interface platform may receive medical data and provide medical safety reporting capabilities including reporting of history data and real-time visual monitoring data. The graphical interface may be provided through an Internet or intranet interface, and can be made available to users on a restricted access basis.

### BRIEF DESCRIPTION OF THE DRAWINGS

Concept mock ups on pages 1-16 are used to enumerate the features and functions of StreamChRT.

FIG. 1 is a screen shot of an upper portion of a graphical user interface (GUI) for an electronic medical/health record.

FIG. 2 is a screen shot of a lower portion of the graphical user interface (GUI) for the electronic medical/health record shown in FIG. 1.

FIG. 3 is a screen shot of another graphical user interface (GUI) for an electronic medical/health record.

FIG. 4 is another screen shot of the graphical user interface (GUI) for the electronic medical/health record shown in FIG. 3.

FIG. 5 is a screen shot of the patient's Vitals.

FIG. 6 is a screen shot of the patient's Nursing Dashboard/Notes Management.

FIG. 7 is a screen shot of the Daily Nursing Checklist.

FIG. 8 is a screen shot when the Pharm tab is clicked on.

FIG. 9 is a screen shot of the RADIOLOGIST/CARDIOLOGIST NOTES.

FIG. 10 is a screen shot of a Patient's vTouch Schedule.

FIG. 11 is a screen shot of a vConsult.

FIG. 12 is a screen shot of a vRounds.

FIG. 13 is a screen shot of a vConference.

FIG. 14 is a screen shot of a vVistingHours.

FIG. 15 is a screen shot of a PATIENT DISCHARGE CHRT.

FIG. 16 is a screen shot of a Patient and Family window.

### DETAILED DESCRIPTION

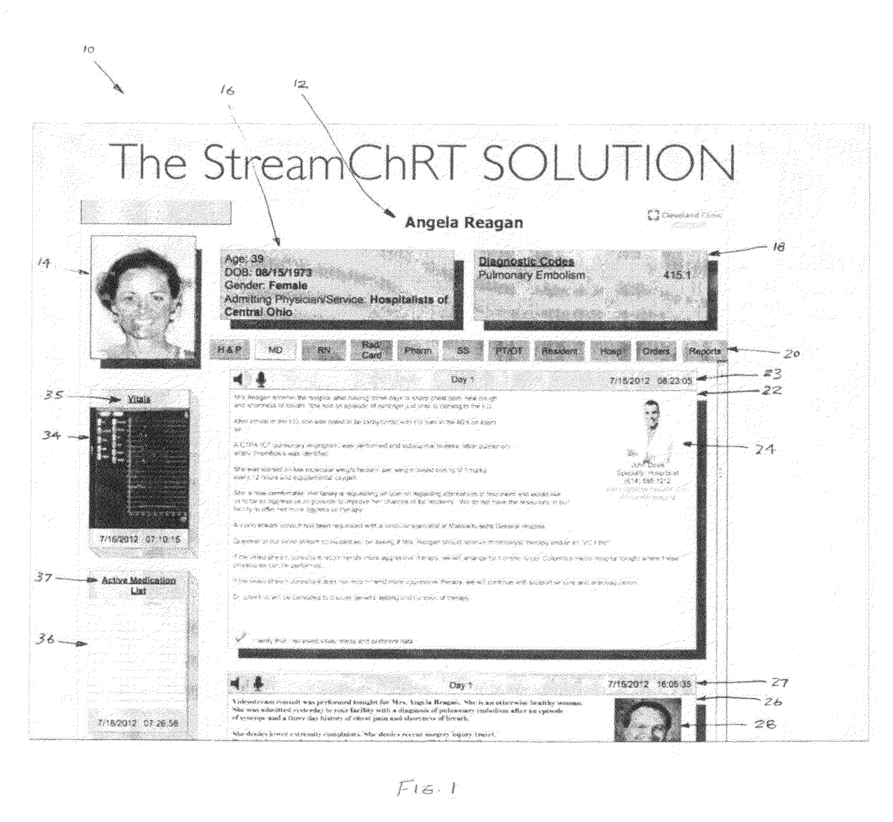

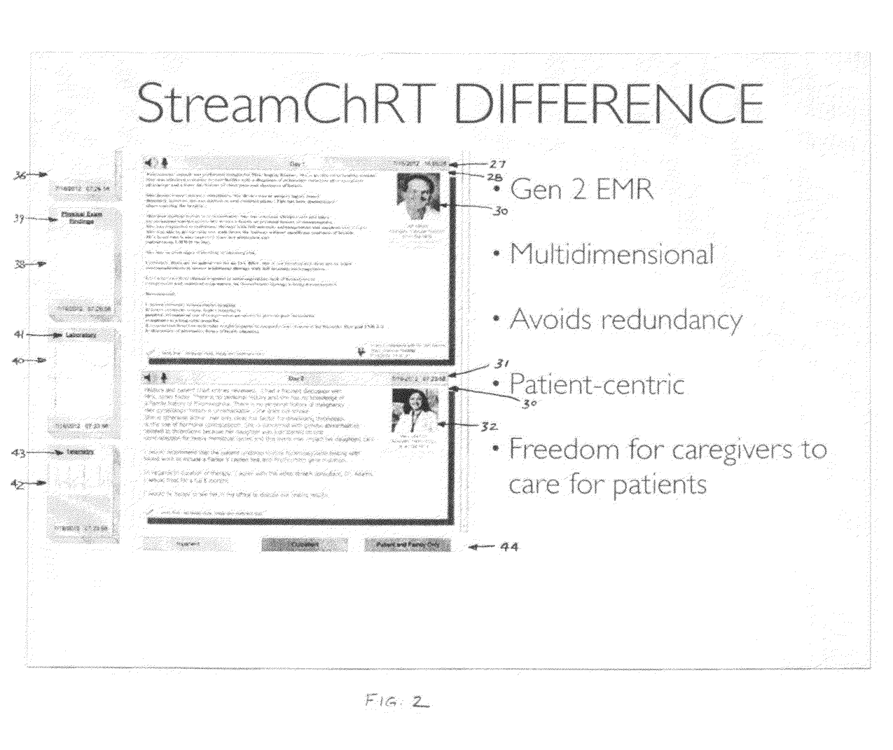

A graphical user interface (GUI) 10 for an electronic medical/health record is shown in FIGS. 1 to 2.

The graphical user interface 10 boldly displays the name 12 of the patient (e.g. ANGELA REAGAN) in the center of a right column, and a digital image 14 of the patient in the left upper corner.

As shown in FIG. 1, the graphical user interface 10 displays a left display window 16 and right display window 18 located immediately below the patient's name 12. The left display window 16 displays the patient identifying information including, for example, patient's age (e.g. 39), date of birth (e.g. DOB, 08/15/1973), gender (e.g. female), and admitting medical facility (e.g. Hospitalists of Central Ohio). A right display window 18 displays the diagnostic codes from the patient (e.g. Pulmonary Embolism).

An upper tool bar 20 is provided immediately below the first patient information window 16 and second patient information window 18. The upper tool bar 20 has a plurality of categories to select from, including H&P (History and Physical Examination); MD (Physicians); RN (Registered Nurses); Rad/Card (Radiation/Cardiology); Pharm (Pharmacy); SS (Social Security); PT/OT (Physical Therapy/Occupational Therapy); Resident (Resident physicians); Hosp (Hospital); Orders (Physician Orders); and Reports (Patient Reports). The category selected by the user to identify the type of caregiver entering information into a particular patient record.

A first patient record window 22 is provided to allow a first caregiver (e.g. John Davis, Specialty, Hospitalist) to enter a first patient record (e.g. patient's condition, patient's response to caregiver's questions answered by patient, caregiver observations, patient treatment) into the electronic medical/health record. The first patient record is date stamped with the time and date in a banner 23. A digital image 24 of the first caregiver is provided as an overlay in the first expandable window 22 along with identification of the first caregiver (e.g. name, specialty, phone number, email hyperlink, and StreamMessaging hyperlink) displayed immediately below the digital image 24.

In FIGS. 1 and 2, a second patient record window 26 is provided immediately below the first expandable window 22 to allow a second caregiver (e.g. Jeff Adams, Specialty, Vascular Surgeon) to enter a second patient record later in time than the first patient record. The second patient record is date stamped with the time and date in a banner 27. A digital image 28 of the second caregiver is provided as an overlay in the second expandable window 26 along with identification of the second caregiver (e.g. name, specialty, phone number, email hyperlink, and StreamMessaging hyperlink) displayed immediately below the digital image 28.

In FIG. 2, a third patient record window 30 is provided immediately below the second expandable window 26 to allow a third caregiver (e.g. Mary Libertino, Specialty, Hematology) to enter a third patient record even later in time than the first and second patient records. The third patient record is date stamped with the time and date in a banner 31. A digital image 32 of the third caregiver is provided as an overlay in the third expandable window 30 along with identification of the third caregiver (e.g. name, specialty, phone number, email hyperlink, and StreamMessaging hyperlink) displayed immediately below the digital image 32.

A plurality of real time patient information windows are provided in the left column in FIGS. 1 and 2. For example, a first real time window 34 displays the patient's real time vitals, a second real time window 36 displays the patient's real time active medication list, a third real time window 38 displays the patient's real time physical exam findings, a fourth real time window 40 displays the patient's real time laboratory results, and a fifth real time window 42 displays the patient's real time telemetry. The patient information real time windows 34, 36, 38, 40, 42 are each provided with a link 35, 37, 39, 41, 43 to expand the respective patient information real time windows when clicked on.

A lower tool bar 44 is provided below the last entered patient record, as shown in FIG. 2. The second tool bar 44 allows a user to select Inpatient, Outpatient, or Patient and Family Only to select the type of video conferencing.

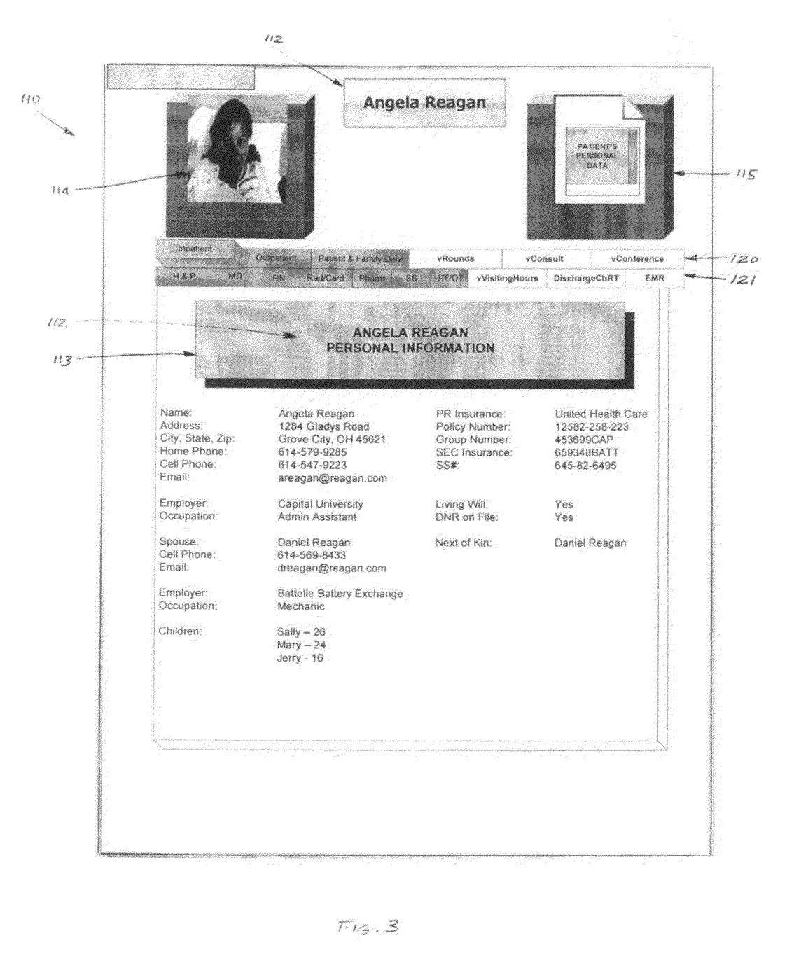

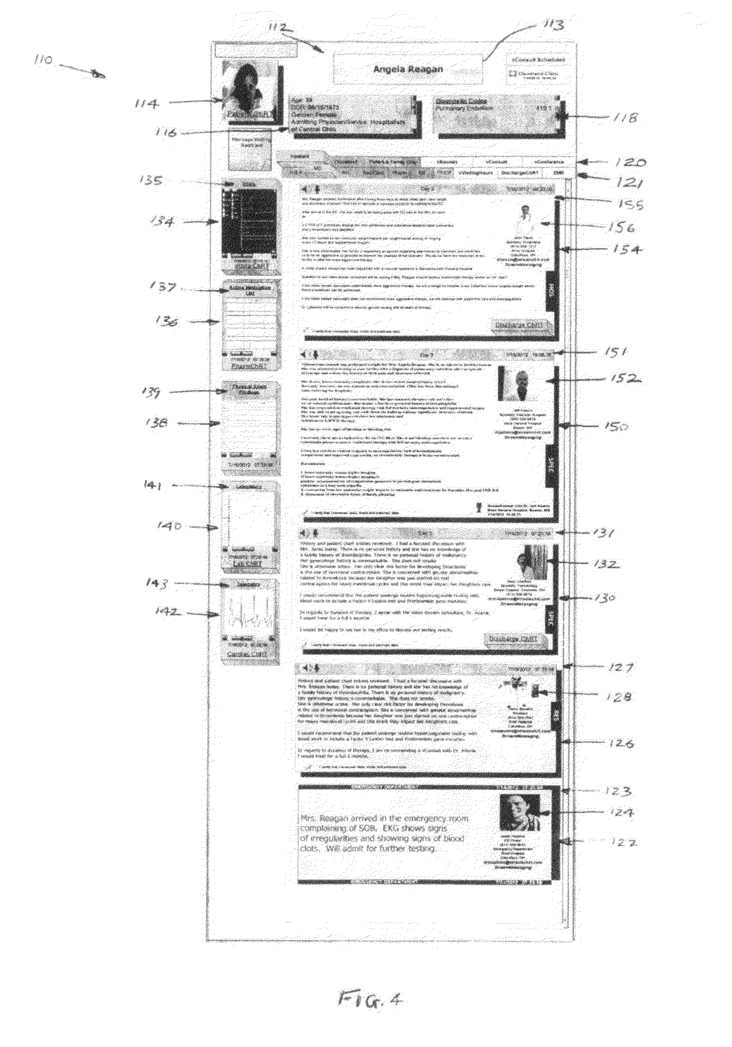

Another graphical user interface (GUI) 110 for an electronic medical/health record is shown in FIGS. 3 and 4.

As shown in FIG. 3, the graphical user interface 110 boldly displays the name 112 of the patient (e.g. ANGELA REAGAN) in a center display window 113, and a digital image 114 of the patient is provided in the upper left corner of the graphical user interface 110. A right window 115 displays the title “PATENT'S PERSONAL DATA.”

An upper tool bar 120 is provided below the center display window 113 and digital image 114. The upper tool bar 120 has a plurality of categories to select from, including Inpatient, Outpatient, Patient & Family Only, vRounds, vConsult, and vConference.

A lower tool bar 121 is provided immediately below the upper tool bar 120. The lower tool bar 121 has a plurality of categories to select from, including H&P (History and Physical Examination); MD (Physicians); RN (Registered Nurses); Rad/Card (Radiation/Cardiology); Pharm (Pharmacy); SS (Social Security); PT/OT (Physical Therapy/Occupational Therapy); vVisitingHours (Visiting Hours); DischargeChRT (Discharge Chart); and EMR (Electronic Medical Record). The category selected by the user is to identify the type of caregiver entering information into a particular patient record.

As shown in FIG. 3, when the “Inpatient” tab is clicked on in the upper tool bar 120, the patient's personal information appears (i.e. ANGELA REAGAN PERSON INFORMATION). The patients name, address, home phone number, cell phone number, email address, employer, occupation, spouse, spouse's name, spouse's cell phone number, spouse's email address, spouse's employer, spouse's occupation, patient's children names, patients children ages, patient's health insurance company name, health insurance policy number, health insurance group number, patient's SEC insurance number, patient's social security number, whether patient has a living will, whether patient as a “do not resuscitate or “No Code” on file, and a listing of Next of Kin.

As shown in FIG. 4, when both the “Inpatient” tab is clicked on in the upper tool bar 120, and then the “MD” tab is clicked on in the lower tool bar, the graphical user interface 110 displays a left display window 116 and right display window 118 located immediately below the patient's name 112. The left display window 116 displays the patient identifying information including, for example, patient's age (e.g. 39), date of birth (e.g. DOB, 08/15/1973), gender (e.g. female), and admitting medical facility (e.g. Hospitalists of Central Ohio). A right display window 118 displays the diagnostic codes from the patient (e.g. Pulmonary Embolism).

As shown in FIG. 4, a first patient record window 122 is provided to allow a first caregiver (e.g. Jason Hopkins, ED Doctor) to enter a first patient record (e.g. patient's condition, patient's response to caregiver's questions answered by patient, caregiver observations, patient treatment) into the electronic medical/health record. The first patient record is date stamped with the time and date in a banner 123. A digital image 124 of the first caregiver is provided as an overlay in the first expandable window 122 along with identification of the first caregiver (e.g. name, specialty, phone number, medical facility, location, email hyperlink, and StreamMessaging hyperlink) displayed immediately below the digital image 124.

As shown in FIG. 4, a second patient record window 126 is provided immediately above the first expandable window 122 to allow a second caregiver (e.g. Henry Stevens, Resident) to enter a second patient record later in time than the first patient record. The second patient record is date stamped with the time and date in a banner 127. A digital image 128 of the second caregiver is provided as an overlay in the second expandable window 126 along with identification of the second caregiver (e.g. name, specialty, phone number, email hyperlink, and StreamMessaging hyperlink) displayed immediately below the digital image 128.

As shown in FIG. 4, a third patient record window 130 is provided immediately above the second expandable window 126 to allow a third caregiver (e.g. Mary Libertino, Specialty, Hematology) to enter a third patient record even later in time than the first and second patient records. The third patient record is date stamped with the time and date in a banner 131. A digital image 132 of the third caregiver is provided as an overlay in the third expandable window 130 along with identification of the third caregiver (e.g. name, specialty, phone number, email hyperlink, and StreamMessaging hyperlink) displayed immediately below the digital image 132.

As shown in FIG. 4, a fourth patient record window 150 is provided immediately above the third expandable window 130 to allow a fourth caregiver (e.g. Jeff Adams, Specialty, Vascular Surgeon) to enter a fourth patient record even later in time than the first, second, and third patient records. The fourth patient record is date stamped with the time and date in a banner 151. A digital image 152 of the fourth caregiver is provided as an overlay in the fourth expandable window 150 along with identification of the fourth caregiver (e.g. name, specialty, phone number, email hyperlink, and StreamMessaging hyperlink) displayed immediately below the digital image 152.

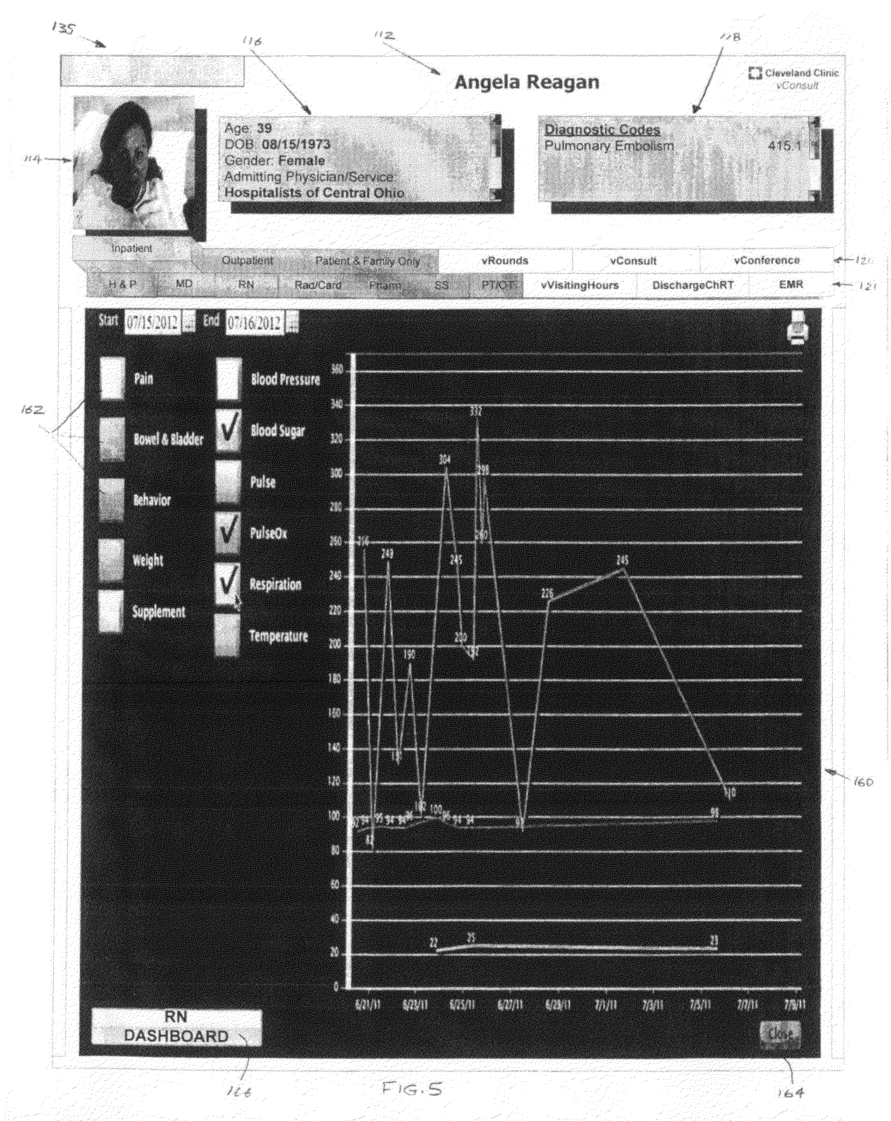

As shown in FIG. 5, a fifth patient record window 154 is provided immediately above the fourth expandable window 150 to allow a fourth caregiver (e.g. John Davis, Specialty, Hospitalist) to enter a fifth patient record even later in time than the first, second, third, and fourth patient records. The fifth patient record is date stamped with the time and date in a banner 155. A digital image 156 of the fourth caregiver is provided as an overlay in the fifth expandable window 154 along with identification of the fourth caregiver (e.g. name, specialty, phone number, email hyperlink, and StreamMessaging hyperlink) displayed immediately below the digital image 156.

As shown in FIG. 4, a plurality of patient information real time windows are provided in the left column. For example, a first patient information real time window 134 displays the patient's real time vitals; a second patient information real time window 136 displays the patient's real time active medication list, a third patient information real time window 138 displays the patient's real time physical exam findings, a fourth patient information real time window 140 displays the patient's real time laboratory results, and a fifth patient information real time window 142 displays the patient's real time telemetry. The patient information real time windows 134, 136, 138, 140, and 142 are each provided with a link 135, 137, 139, 141, 143 to expand the respective windows when clicked on.

As shown in FIGS. 4 and 5, clicking on the Vitals link 135 (FIG. 4) expands the Vitals window 135 showing the patient's vitals, including Pain, Bowel & Bladder, Behavior, Weight, Supplement, Blood Pressure, Blood Sugar, Pulse, PulseOx, Respiration, and Temperature. A graph 160 of the vitals can be displayed by a measurement (e.g. quantity) verses date when clicking on the particular vital. In FIG. 4, the vitals for Blood Sugar, PulseOx, and Respiration are clicked on and each shown with a check mark is the corresponding selected display boxes 162 to display each of these particular vitals in the graphical representation 160. The opened Vitals window 135 includes a Close tab 164 to return to the main menu in FIG. 4.

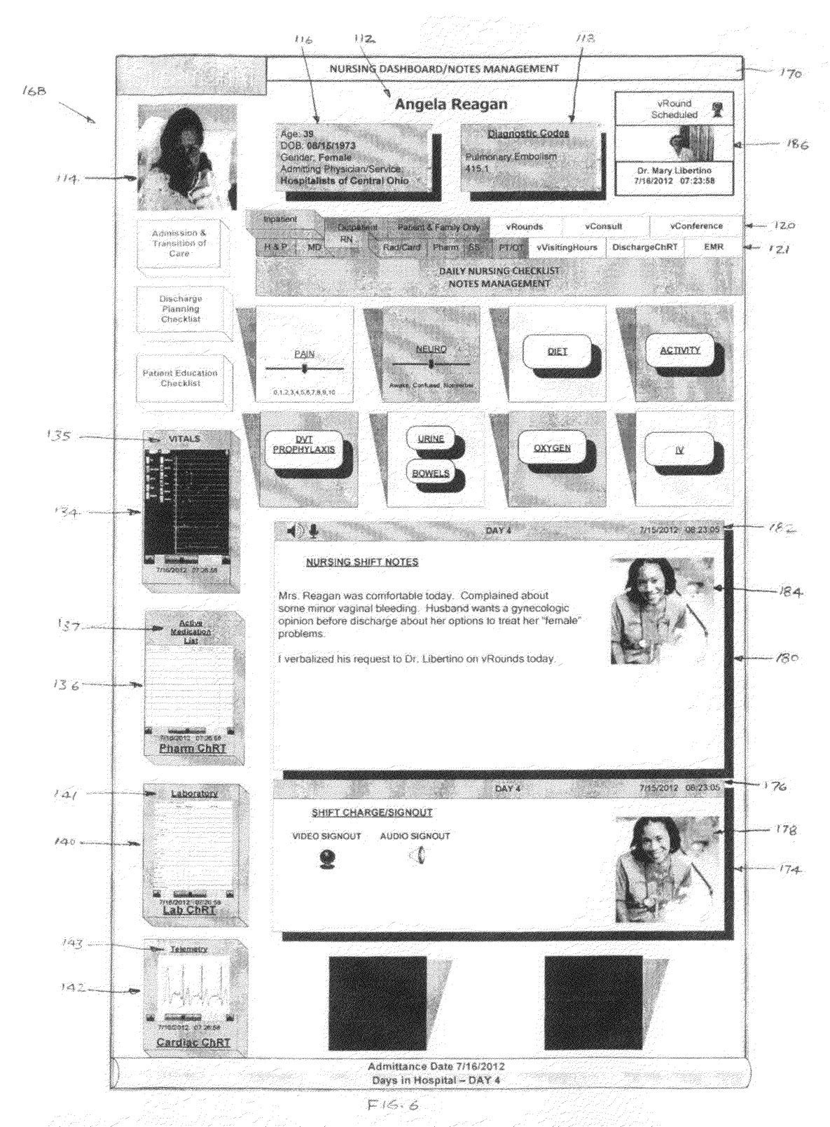

The opened Vitals window 135 includes an RN DASHBOARD tab 166 open the RN DASHBOARD window 168 shown in FIG. 6. The RN DASHBOARD window 168 displays the banner 170 stating “NURSING DASHBOARD/NOTES MANAGEMENT” and a banner 172 stating “DAILY NURSING CHECKLIST NOTES MANAGEMENT.” Graphical displays (e.g. slide bars) of the level of PAIN, NEURO, DIET, ACTIVITY, DVT PROPHYLAXIS, URINE/BOWELS, OXEGEN; and IV are provided. Other type of graphical displays can be used to visual indicate levels of these important patient factors.

As shown in FIG. 6, the opened RN DASHBOARD window 168 displays a nurse record window 174. The nurse record window 174 comprises a banner 176 displaying the DAY and a date/time stamp, a digital nurse image 178 displaying the acting nurse, and a nurse SHIFT CHARGE/SIGNOUT record to provide a VIDEO SIGNOUT or AUDIO SIGNOUT for the nurse.

Further, the RN DASHBOARD window 168 also displays a patient record window 180. The patient record window 180 comprises a banner 182 displaying the DAY and a date/time stamp, a digital image 184 of the nurse, and the NURSING SHIFT NOTES.

The RN DASHBOARD window 168 also comprises a Virtual Round window 186 showing a vRound Scheduled with Dr. Mary Libertino with date and time; an Admission & Transition of Care window 188, a Discharge Planning Checklist window 190, and Patient Education Checklist window 192.

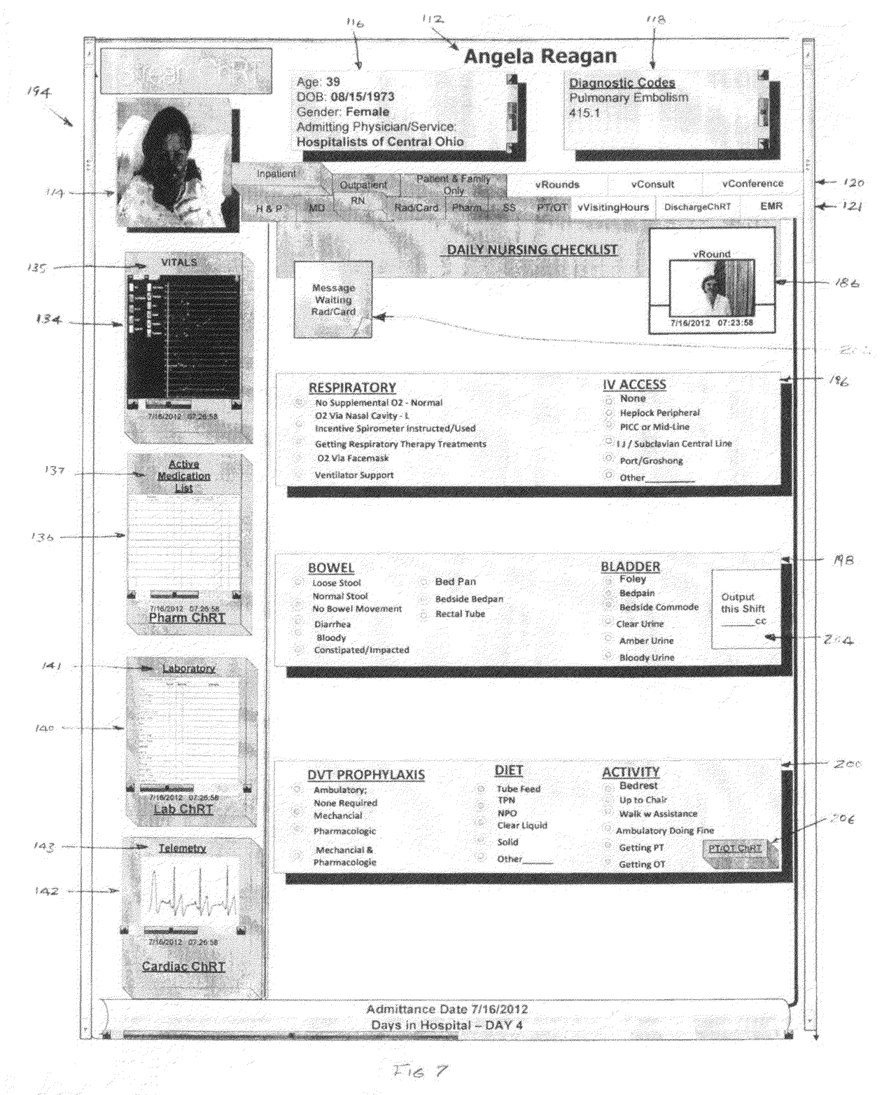

As shown in FIG. 7, the opened DAILY NURSING CHECKLIST window 194 comprises a checklist window 196 for RESPIRATORY and IV ACCESS, a checklist window 198 for BOWEL and BLADDER, and a checklist window 200 for DVT PROPHYLAXIS, DIET, and ACTIVITY.

The DAILY NURSING CHECKLIST window 194 also comprises a Message Waiting Rad/Card tab 202, Output this Shift ______ cc tab 204, and PT/OT ChRT tab 206.

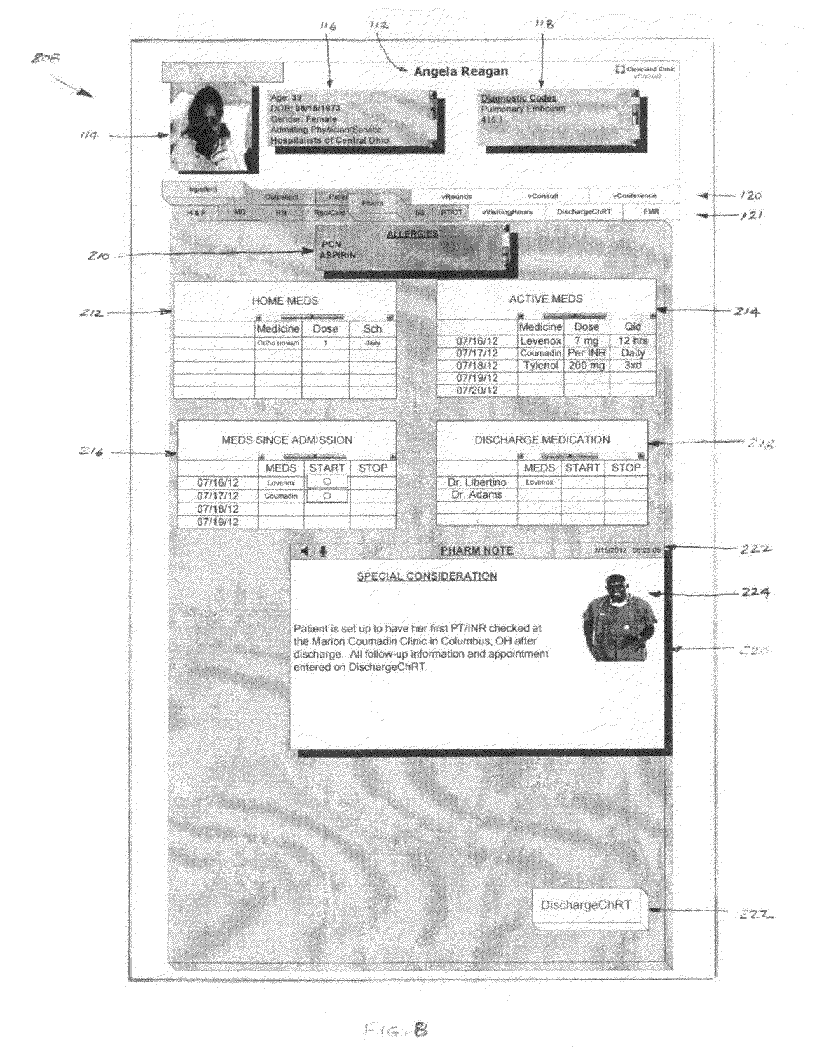

As shown in FIG. 8, upon clicking on the inpatient tab in the upper tool bar 120 and the Pharm tab, the Pharmacy window 208 opens.

The Pharmacy window 208 comprises an ALLERGIES window 210 showing PCN and ASPIRIN.

The Pharmacy window 208 further comprises a HOME MEDS chart 212, ACTIVE MEDS chart 214, MEDS SINCE ADMISSION chart 216, a DISCHARGE MEDICATION chart 218, a PHARM NOTE window 220 having a date and time stamped PHARM NOTE banner 222, and a Discharge ChRT tab 224.

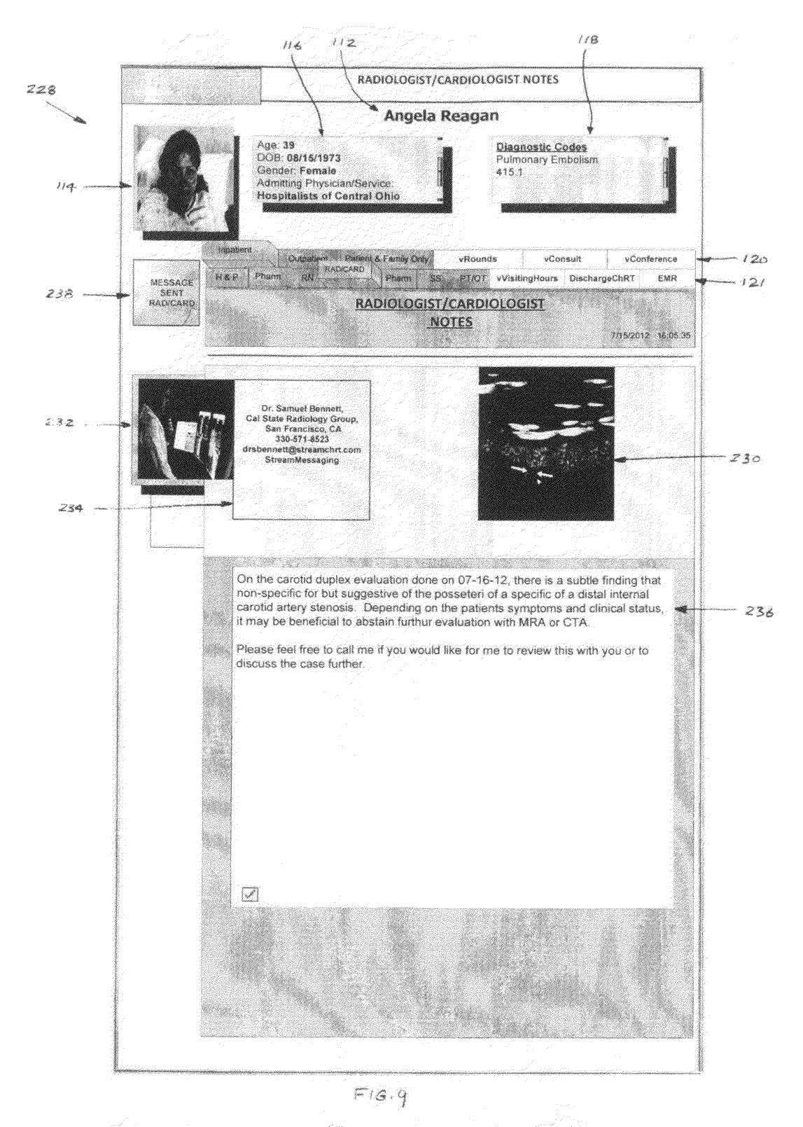

As shown in FIG. 9, upon clicking on the Inpatient tab in the upper tool bar 120 and the RAD/CARD tab, the RADIOLOGIST/CARDIOLOGIST NOTES window 228 opens:

The RADIOLOGIST/CARDIOLOGIST NOTES window 228 comprises a Radiologist digital image 232, a Radiologist identification and contact information window 234 (i.e. Dr. Samuel Bennett, Cal State Radiology Group, San Francisco, Calif., 330-571-8523, drsbennett@streamchrt.com, StreamMessaging, a patient record window 236, and a MESSAGE SENT RAD/CARD tab 238.

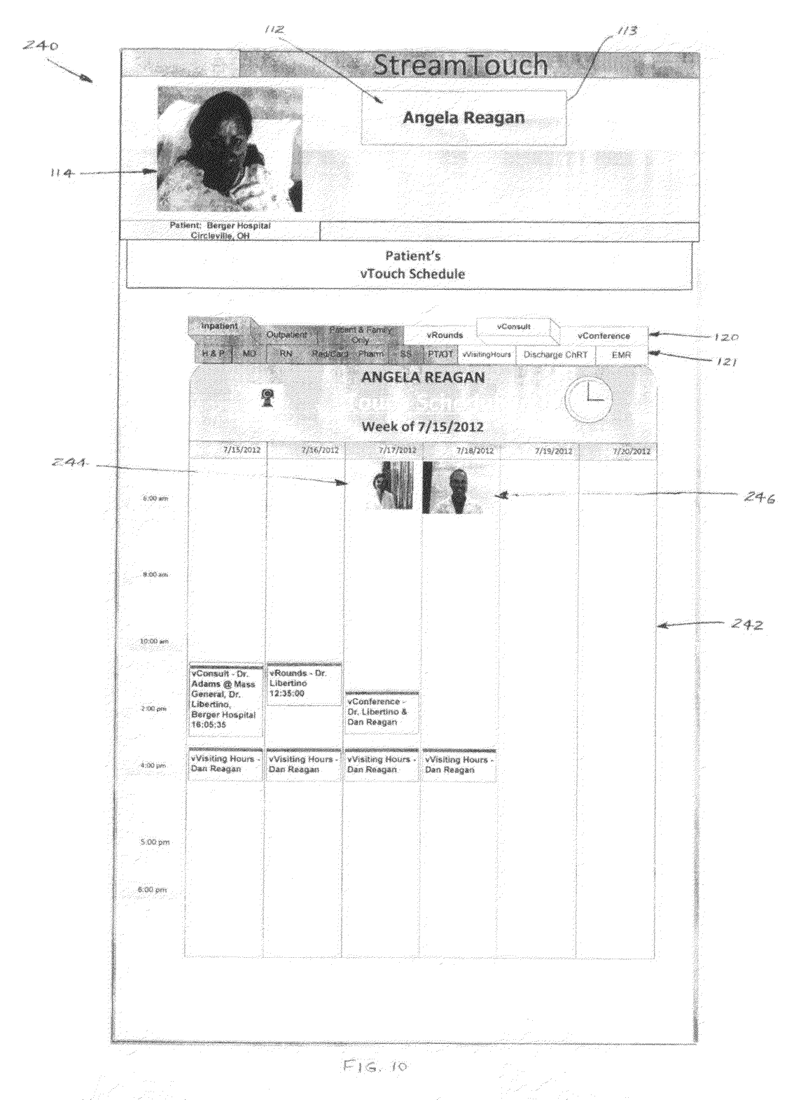

As shown in FIG. 10, upon clicking on the Inpatient tab and vConsult tab in the upper tool bar 120, the Patient's vTouch Schedule window 240 opens.

The Patient's vTouch Schedule window 240 comprises a vTouch Schedule calendar window 242 showing the times and dates for vConsults, vVisitingHours, vRounds, vConferences, and healthcare provider digital images 244, 246 of the treating health care provider in the date columns.

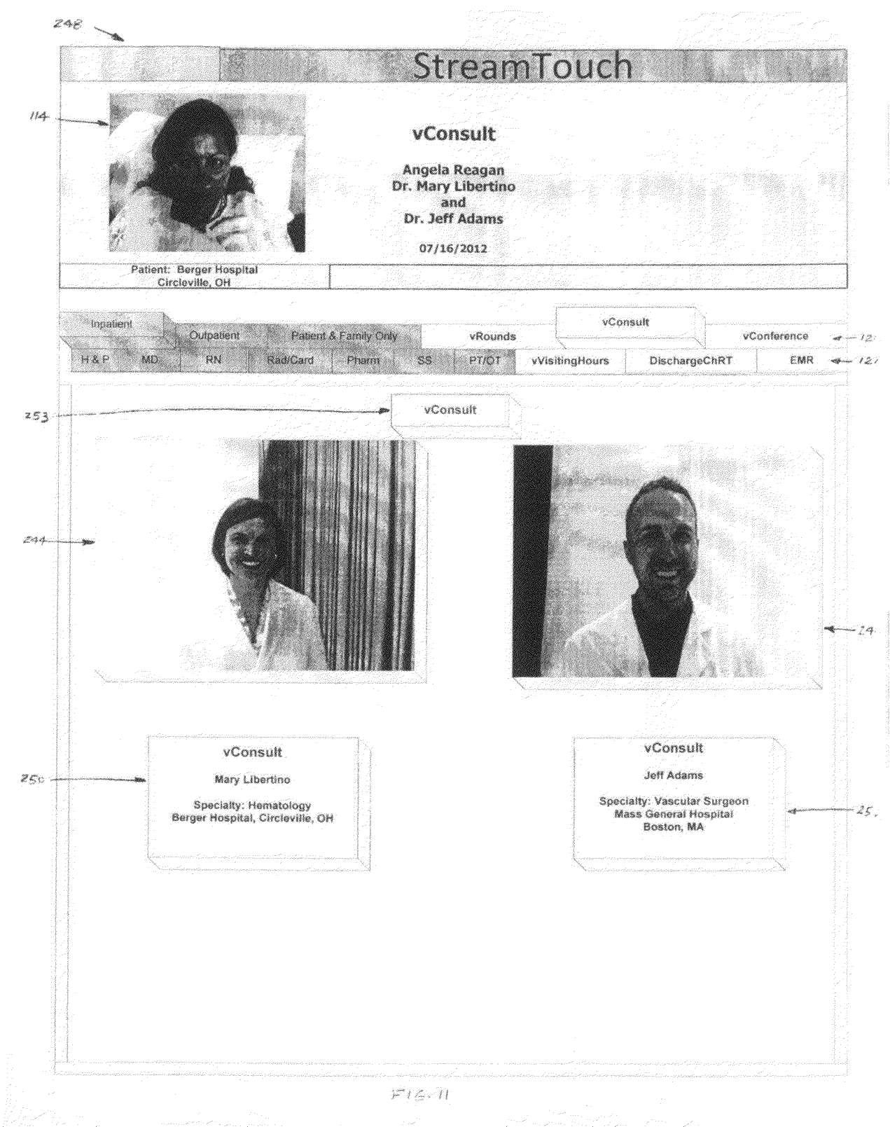

As shown in FIG. 11, upon clicking on one of the digital images of the healthcare providers in the vTouch Schedule calendar window 242, as shown in FIG. 10, the vConsult window 248 opens.

The vConsult window 248 comprises healthcare provider digital images 244, 246, and vConsult healthcare provider windows 250, 252 with the name, specialty, and name of healthcare facility. The real time video conference among the patient and healthcare providers is initiated by clicking on the vConsult tab 253. vConsult provides for virtual consults among the patient and healthcare providers. For example, vConsult provides for virtual consults with other specialists in the same hospital or at different hospitals.

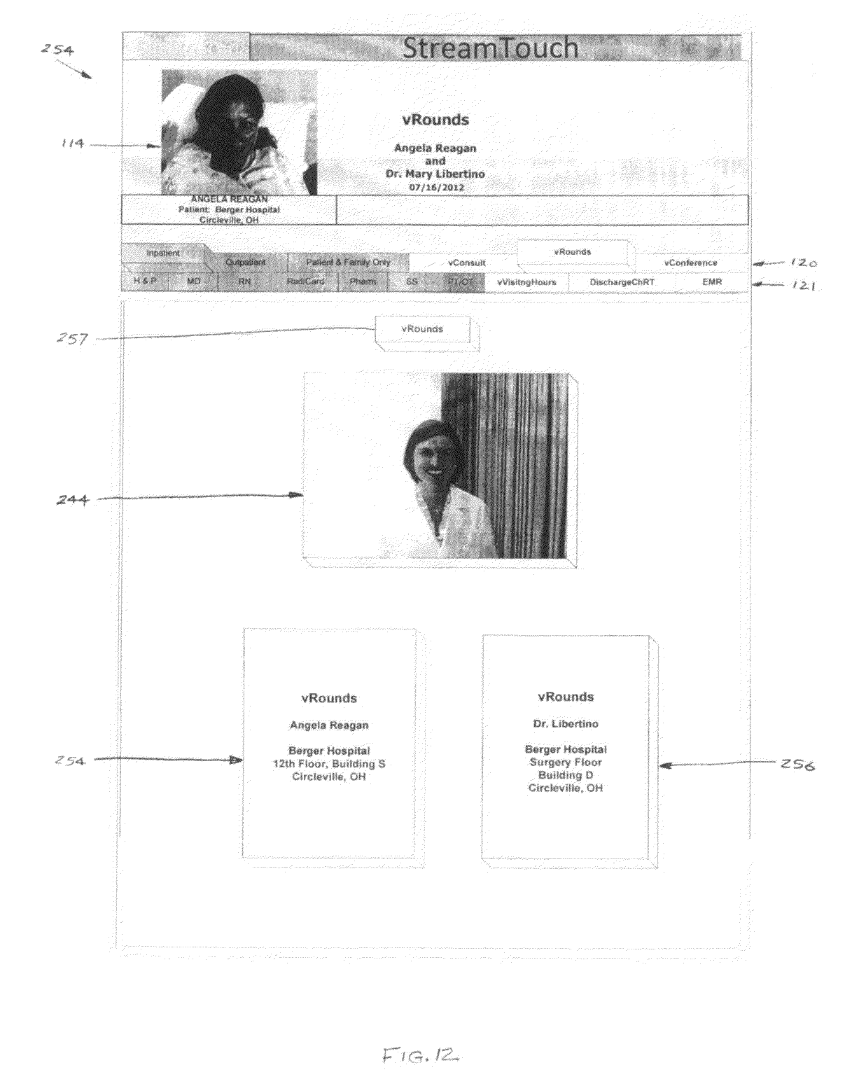

As shown in FIG. 12, upon clicking on the Inpatient tab and vRounds tab in the upper tool bar 120, the vRounds window 254 is opened.

The vRounds window 254 comprises a healthcare provider digital image 244 and vRounds healthcare provider windows 254, 256 with the name, and name of the healthcare facility. The real time video conference between the patient and healthcare provider is initiated by clicking on the vRounds tab 257. vRounds provides for virtual rounds between the patient and physician.

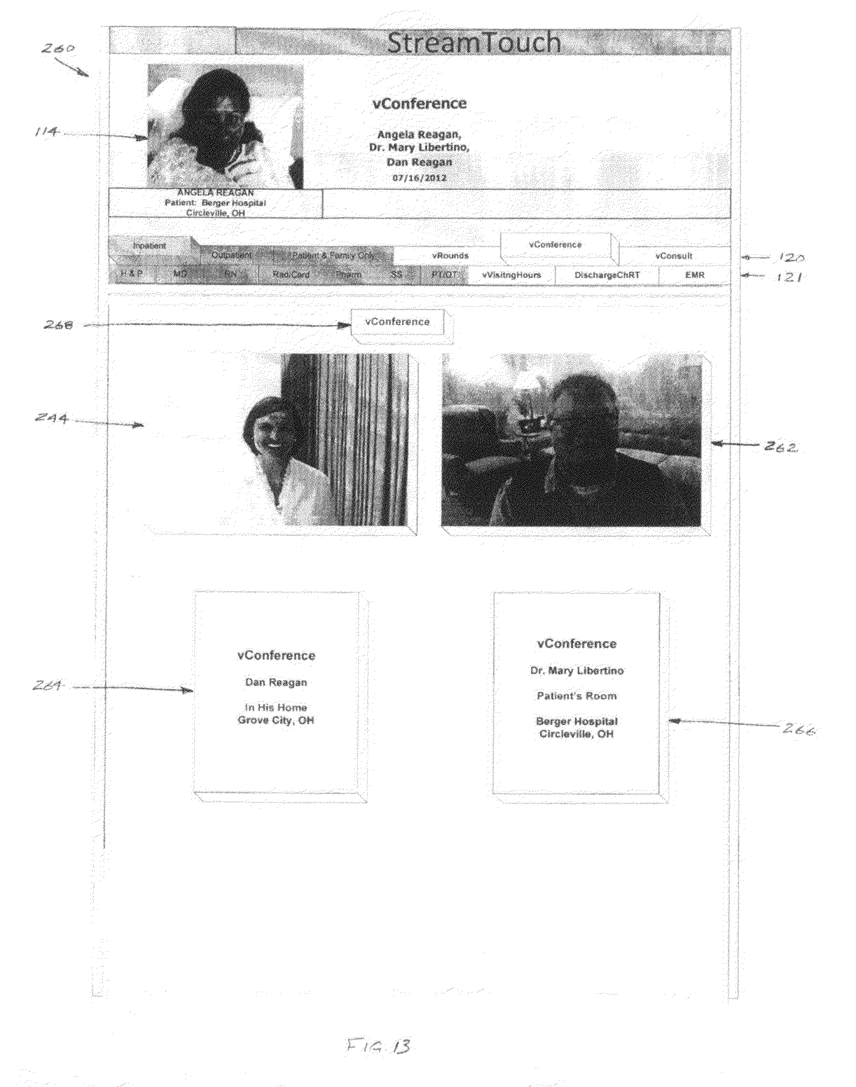

As shown in FIG. 13, upon clicking on the Inpatient tab and vConference tab in the upper tool bar 120, the vConference window 260 is opened.

The vConference window 260 comprises a healthcare provider digital image 244, family member digital image 262, a vConference healthcare provider identification window 264, and a vConference family member identification window 266. The real time video conference among the patient, family member, and healthcare provider is initiated by clicking on the vConference tab 268. vConference provides for virtual conferences with a healthcare professional and family members of patients.

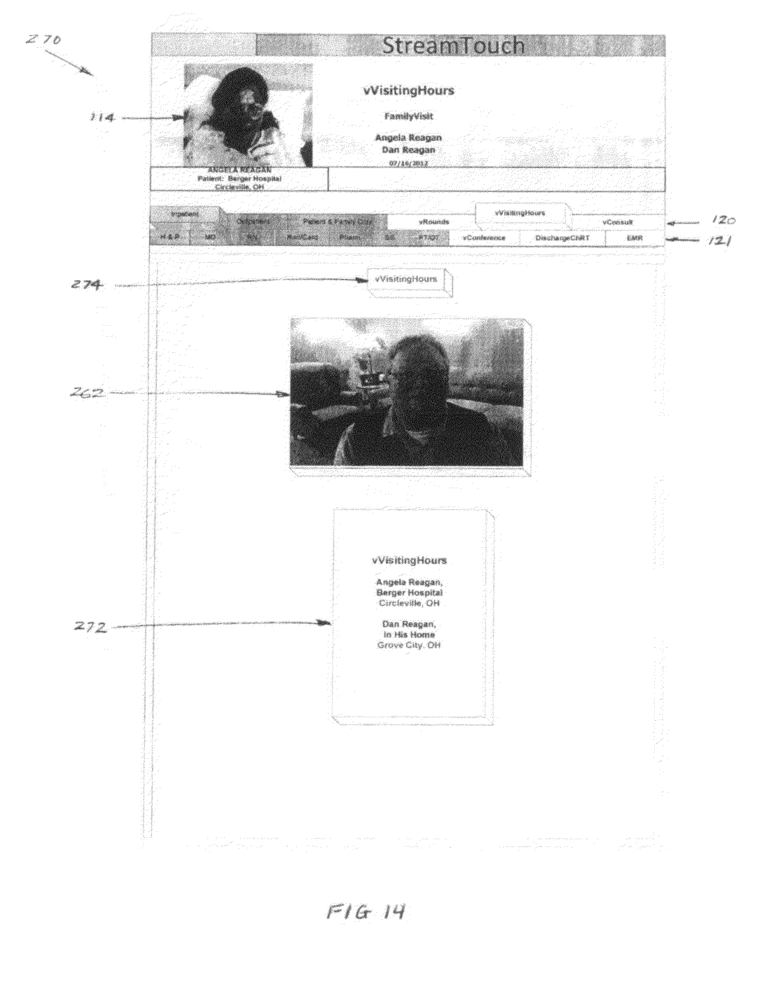

As shown in FIG. 14, upon clicking on the Inpatient tab and vVisitingHours tab in the upper tool bar 120, the vVisitingHours window 270 is opened.

The vVisitingHours window 270 comprises a family member digital image 262, and a vVisitingHours family member identification window 272. The real time video conference between the patient (i.e. Angela Reagan, located in Cleveland, Ohio) and family member (i.e. Dan Reagan, Husband, located in Pittsburgh, Pa.) is initiated by clicking on vVisitingHours tab 274. vVisitingHours provides for virtual visits between patients and their family and friend who are unable to be at the hospital

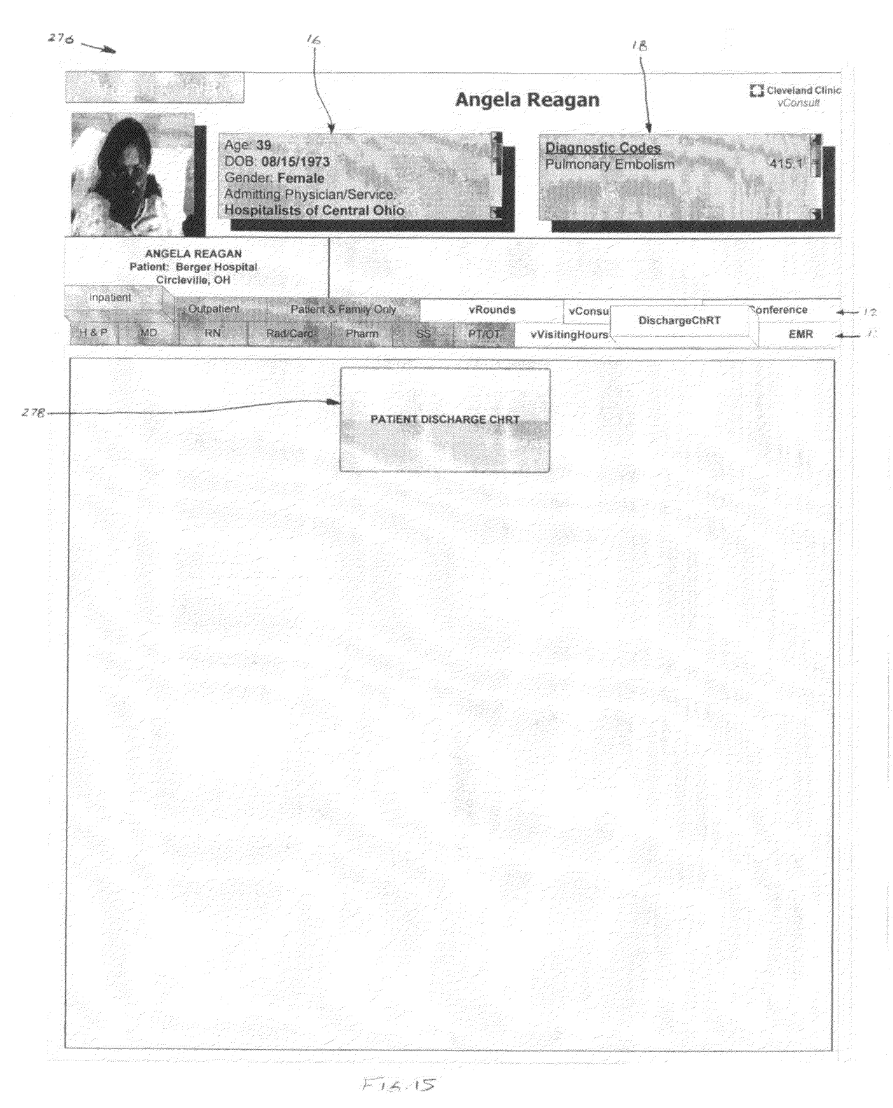

As shown in FIG. 15, upon clicking on the Inpatient tab and DischargeChRT tab in the upper tool bar 120, the PATIENT DISCHARGE CHRT window 276 is opened.

The vVisitingHours window 276 comprises a PATIENT DISCHARGE CHRT 278.

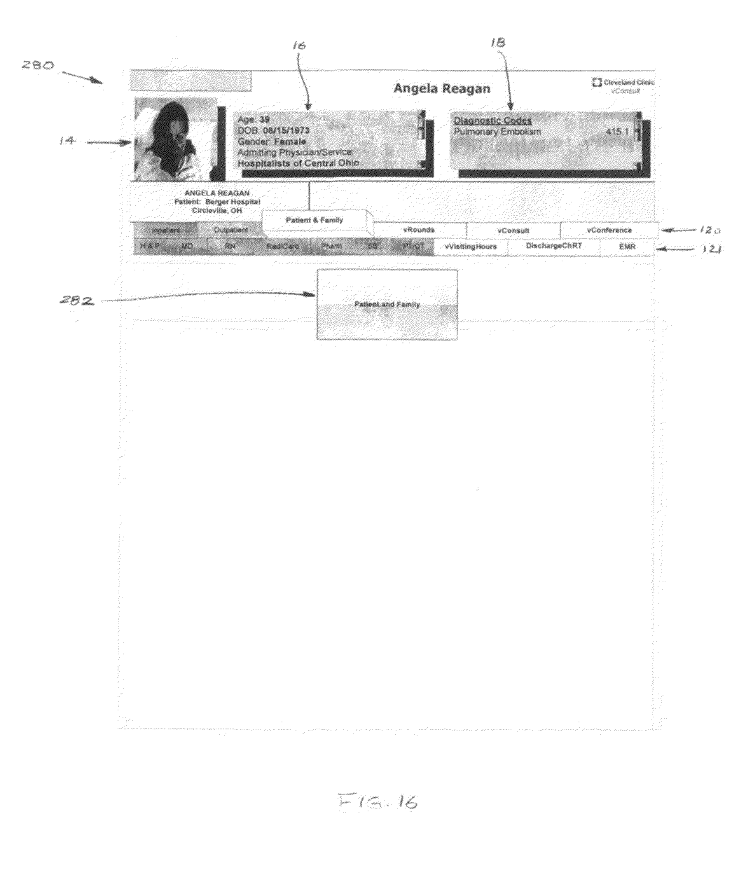

As shown in FIG. 16, upon clicking on the Patient & Family tab in the upper tool bar 120, the Patient and Family window 280 is opened.

The Patient and Family window 280 comprises a Patient and Family window 282.

Any and all instances where the interface or underlying EMR is manipulated in a manner described herein above may be recorded and stored in the interface and/or the EMR.

The present subject matter being thus described, it will be apparent that the same may be modified or varied in many ways. Such modifications and variations are not to be regarded as a departure from the spirit and scope of the present subject matter, and all such modifications and variations are intended to be included within the scope of the following claims.

1. A system, comprising:
a graphical interface, the graphical interface comprising at least one display environment;
electronic medical record (EMR) software;
at least one user input station;
at least one storage device;
a network linking the graphical interface, the EMR software, the at least one user input station and/or the at least one storage device; and
optionally, at least one electronically connected medical device connected to the network.

2. The system according to claim 1, wherein the graphical interface comprises one or more of a patient image, one or more hyperlinks toggling to collaborating specialists, individualized preset font preferences that accompany each health provider's notes allowing for at-a-glance identification of a specific physician or physicians, color coded areas corresponding to transitions in care area on the chart displayed by the interface, highlighted entries configured to allow review events/number of transitions a patient has experienced during care.

3. The system according to claim 1, wherein the at least one user input station comprises a keyboard, voice recognition tool, video formats, or the like configured to input data into the interface.

4. The system according to claim 1, wherein graphical user interface comprises a utility for distinguishing between types of health care providers notations to the chart.

5. The system according to claim 1, wherein the graphical user interface comprises a utility configured to distinguish the area of specialty of a health care practitioner.

6. The system according to claim 4 or 5, wherein the utility is in the form of an icon, a font-type, a font color, a background color or background image.

7. The system according to claim 1, wherein the graphical interface comprises at least one thumbnail side bar comprising data in a display environment.

8. The system according to claim 7, wherein the data is updated in real time as data is input and/or extracted from the electronic medical record or other linked equipment.

9. The system according to claim 8, wherein the data comprises one or more of last 24 hour graphics of patient temperature, heart rate, ins and outs, and an active medication list.

10. The system according to claim 1, wherein at least one of the one or more display environments comprises a virtual remote consultation environment.

11. The system according to claim 10, wherein the virtual remote consultation environment is configured such that one or more institutions can communicate with one another via videoconferencing.

12. The system according to claim 1, wherein the at least one display environment is one or more selected from the group consisting of an inpatient display environment, an outpatient display environment, a first medical care facility display environment, a second medical care facility display environment, a third medical care facility display environment, one or more laboratory test result display environments.

13. The system according to claim 1, wherein the at least one display environment comprises one or more of a digital image of the patient, patient information, admitting physician/service, diagnostic codes box, consecutive day medical notes, digital image of admitting physician accompanying medical notes, and/or a time and date window.

14. The system according to claim 13, wherein at least one of the at least one display environments comprises one or more of the tools or utilities selected from the group consisting of patient vitals, an active medication list, physical examination information, laboratory data and telemetry.

15. The system according to claim 1, wherein the at least one of the at least one display environments comprises a toolbar comprising one or more tabs linked to data relevant to H&P (History and Physical Examination), MD (Physicians), RN (Registered Nurses), Rad/Card (Radiology/Cardiology), Pharm (Pharmacy), SS (Social Security), PT/OT (Physical Therapy/Occupational Therapy), Resident (Resident physicians), Hosp (Hospital), Orders (Physician Orders) and/or Reports (Patient Reports).

16. The system according to claim 1, wherein the at least one of the at least one display environments comprises a toolbar comprising one or more tabs linked to inpatient data, outpatient data, patient and/or patient's family data.

17. The system according to claim 1, wherein the graphical interface comprises one or more of a video conferencing feature, a social media layout with visual patient and caregiver identifiers, colored font to identity transitions of care, real time streaming of patient data, encrypted data storage for future data mining projects, instant communication and collaboration software and/or time stamp technology in real time.

18. A method for maintaining and/or updating electronic medical records, comprising:
inputting data into a graphical user interface, or extracting data from an electronic medical record (EMR) or other electronically linked device or database, the inputting or extracting being performed on a sufficiently programmed computer;
updating the graphical user interface; and
displaying the updated graphical user interface.

19. The method according to claim 18, wherein the graphic user interface comprises at least one display environment.

20. The method according to claim 19, wherein the graphic interface comprises one or more of a patient image, one or more hyperlinks toggling to collaborating specialists, individualized preset font preferences that accompany each health provider's notes allowing for at-a-glance identification of a specific physician or physicians, color coded areas corresponding to transitions in care area on the chart displayed by the interface, highlighted entries configured to allow review events/number of transitions a patient has experienced during care.

21. The method according to claim 18, wherein the at least one user input station comprises a keyboard, voice recognition tool, video formats, or the like configured to input data into the interface.

22. The method according to claim 18, wherein the graphical user interface comprises a utility for distinguishing between types of health care providers notations to the chart.

23. The method according to claim 18, wherein the graphical user interface comprises a utility configured to distinguish the area of specialty of a health care practitioner.

24. The method according to claim 22 or 23, wherein the utility is in the form of an icon, a font-type, a font color, a background color or background image.

25. The method according to claim 18, wherein the graphical interface comprises at least one thumbnail side bar comprising data in a display environment.

26. The method according to claim 25, wherein the data is updated in real time as data is input and/or extracted from the electronic medical record or other linked equipment.

27. The method according to claim 26, wherein the data comprises one or more of last 24 hour graphics of patient temperature, heart rate, ins and outs, and an active medication list.

28. The method according to claim 18, wherein at least one of the one or more display environments comprises a virtual remote consultation environment.

28. The method according to claim 27, wherein the virtual remote consultation environment is configured such that one or more institutions can communicate with one another via videoconferencing.

29. The method according to claim 28, wherein the at least one display environment is one or more selected from the group consisting of an inpatient display environment, an outpatient display environment, a first medical care facility display environment, a second medical care facility display environment, a third medical care facility display environment, one or more laboratory test result display environments.

30. The method according to claim 18, wherein the at least one display environment comprises one or more of a digital image of the patient, patient information, admitting physician/service, diagnostic codes box, consecutive day medical notes, digital image of admitting physician accompanying medical notes, and/or a time and date window.

31. The method according to claim 30, wherein at least one of the at least one display environments comprises one or more of the tools or utilities selected from the group consisting of patient vitals, an active medication list, physical examination information, laboratory data and telemetry.

32. The method according to claim 18, wherein the at least one of the at least one display environments comprises a toolbar comprising one or more tabs linked to data relevant to H&P (History and Physical Examination), MD (Physicians), RN (Registered Nurses), Rad/Card (Radiology/Cardiology), Pharm (Pharmacy), SS (Social Security), PT/OT (Physical Therapy/Occupational Therapy), Resident (Resident physicians), Hosp (Hospital), Orders (Physician Orders) and/or Reports (Patient Reports).

33. The method according to claim 18, wherein the at least one of the at least one display environments comprises a toolbar comprising one or more tabs linked to inpatient data, outpatient data, patient and/or patient's family data.

34. The method according to claim 33, wherein the graphical interface comprises one or more of a video conferencing feature, a social media layout with visual patient and caregiver identifiers, colored font to identity transitions of care, real time streaming of patient data, encrypted data storage for future data mining projects, instant communication and collaboration software and/or time stamp technology in real time.

35. A computer-implemented patient electronic medical/health record method, comprising:
providing a graphical user interface comprising a display environment for the electronic medical/health record, the display environment comprising the patient's name, patient's identifying information, a digital image of the patient, care giver identifying information, a digital image of the care giver, and at least one patient medical record window.

36. The method according to claim 35, wherein the patient's identifying information comprises age, date of birth, gender, and identity of admitting care giving facility in a first display window.

37. The method according to claim 36, wherein the patient's identifying information further comprises diagnostic codes in a second display window.

38. The method according to claim 35, wherein the display environment comprises an upper toolbar.

39. The method according to claim 38, wherein the upper toolbar comprises a selection of types of caregivers.

40. The method according to claim 39, wherein the type of caregiver is color coded in the toolbar.

41. The method according to claim 40, wherein the type of caregiver comprises physicians, registered nurses, radiologists, cardiologists, and resident physicians.

42. The method according to claim 37, wherein the upper toolbar comprises at least one category selected from the group consisting of history and physical examination, doctor, registered nurse, radiologist/cardiologist, pharmacy, social security, physical therapy/occupational therapy, resident physician, hospital, orders, and reports.

43. The method according to claim 35, wherein the display environment further comprises one or more real time display windows displaying patient information.

44. The method according to claim 43, wherein the one or more real time display windows are a plurality of real time display windows located in a side column.

45. The method according to claim 44, wherein the real time display windows are expandable.

46. The method according to claim 45, wherein the real time display windows comprise at least one category selected from the group consisting of patient vitals, patient active medication list, patient physical exam findings, patient laboratory, and patient telemetry.

47. A computer-implement electronic medical/health record system, comprising:
providing a graphical user interface comprising a display environment;
displaying a patient digital image on in the display environment of the graphic user interface;
displaying at least one patient medical record window on the display environment of the graphic user interface; and
displaying a caregiver digital image in the patient medical record window.

48. The system according to claim 47, comprising providing at least one real time window displaying real time patient information.

49. The system according to claim 48, wherein the at least one real time window comprises a plurality of separate real time windows displaying different real time patient information in each respective real time window.

50. The system according to claim 47, further comprising providing a virtual consult between the patient and at least on healthcare provider.

51. The system according to claim 47, further comprising providing a virtual round between the patient and a physician.

52. The system according to claim 47, further comprising providing a virtual conference among the patient, family, and friends.
